(19) United States
(12) Patent Application Publication
(10) Pub. No.: US 2007/0186747 A1
(43) Pub. Date: Aug. 16, 2007

(54) DIE CUTTER

(76) Inventors: Faye Angevine, Taipei (TW); Yeqing Deng, Dongguan City, Guangdong (CN)

Correspondence Address: MORRISS OBRYANT COMPAGNI, P.C., 734 EAST 200 SOUTH, SALT LAKE CITY, UT, 84102, US

(21) Appl. No.: 11/614,838

(22) Filed: Dec. 21, 2006

Related U.S. Application Data
(60) Provisional application No. 60/752,443, filed on Dec. 21, 2005.

(51) Int. Cl. B26D 1/12

(52) U.S. Cl. 83/607; 83/686

(57) ABSTRACT

The present invention provides a hinge-type die cutter which includes two flat metal plates. The two metal plates are mutually hinged to form a hinged structure. A recess and engaging projection are mutually offset and include sharpened edges so as to provide a cutting structure when the two plates are brought together. The contours of the projections and recesses define the pattern to be cut with the die cutter. Other projections and recesses are provided that when engaged cause embossing of the material placed therein.

### CROSS-REFERENCE TO RELATED APPLICATION

This application claims priority to U.S. Provisional Patent Application Ser. No. 60/752,443 filed on Dec. 21, 2006.

### FIELD OF THE INVENTION

The present invention relates generally to die cutting devices and more specifically to a die cutter that can simultaneously cut and emboss.

### BACKGROUND OF THE INVENTION

Traditional paper-cut handicraft articles are a kind of popular artwork, which possesses multiple and diverse molds, high value of artistic appreciation, and is quite fit for children's enlightenment education, and this kind of paper-cut patterns have been widely applied in children's education in foreign countries; for example, in USA, this kind of paper-cut pattern products are quite popular, generally paper, plastic slices, rubber sheets or similar materials are cut into letters, cartoons, animals or human patterns etc. to train children's cognition and identification; however, the traditional manual paper cutting method is inefficient in manufacture of this kind of paper-cut pattern products, has poor consistency of patterns, and not fit for mass production; in order to solve such defects, a method suitable for mass production is adopted, i.e., the pattern cutter used to cut pattern is manufactured firstly, its thin blade with sharp cutting edge to be bent for processing patterns is embedded in a flat plate and fixed, then such kind of pattern cutter is used to crush and cut paper or similar flat material, and the material cut off forms a single art pattern with same patterns as the thin blade, i.e., the product required, in case products with different shapes will be manufactured, the pattern cutter should be changed into different shapes; for instance, “a kind of paper cutter” published in China's practical new-type patent with the patent number of 01209608.3 just belongs to such kind of pattern cutter, though this kind of pattern cutter enables mass production of paper-cut patterns, it has obvious defects: (1) the manufacturing cost of such pattern cutter is very high because the processing of thin blade with the same contour as the patterns is comparatively difficult and the processing time is relatively long; (2) such pattern cutter must be placed on flat plate made from nonrigid materials with certain rigidity (such as plastic materials PP, PC, ABS and AS, nylon 66 etc.) during use to ensure the damage to the cutting edge of the pattern cutter is reduced in the normal crush cutting of flat materials, thus it has high operating requirements and is inconvenient for use; (3) the paper patterns cut by such pattern cutter are flat pattern, which are short of three dimensional appeal and not vivid, and fail to show the hierarchical structure of patterns.

### SUMMARY OF THE INVENTION

The present invention provides a die cutter that provides significant advantages over existing die cutting technologies. The die cutter of the present invention has a relatively simple structure that can be relatively inexpensively manufactured in a simple manufacturing process. The die cutter of the present invention can produce sharp-edged and intricate paper cutouts (i.e., die cuts) that are simultaneously embossed to provide three-dimensional characteristics to the die cut. The resulting die cut has clean cut lines and embossed features that are produced in a single process step.

In one embodiment of the present invention, the die cutting device is comprised of a pair of metal plates that are mutually hinged to one another along one side thereof to form a hinged-type structure. Each metal plate has a front side and a back side, with the front sides in a facing arrangement when the two metal plates are folded toward each other about the hinge. The front sides of the metal plates are provided with various mating surfaces that, when engaged either cut or emboss a material placed therein between. That is, the mating surfaces include certain raised portions and recessed portions that engage for cutting in a scissor-like arrangement such that sharp edges are formed along the engaging surfaces so as to cut a material placed therein between. In addition, other mating surfaces include certain raised and recessed portions that when engaged do not cut, but rather emboss the material placed therein by a pressing action. Typically, the material will be paper or card stock of various acceptable thicknesses, but other materials known in the art may be used with the die cutter of the present invention.

In another embodiment, the die cutter/embossing device is comprised of first and second metal plates. A pattern is formed in the first metal plate by a series of raised walls that have sharpened top outer edges and define recesses therein between. A corresponding but offset series of recesses that are sized and shaped to receive the raised walls therein define sharp top edges along their top edges. The raised walls are sized to be slightly offset from the recesses so that the raised walls can fit within the recesses when the two plates are brought together. Because there is relatively little spacing between the walls and the recesses, the sharpened edges will to cut the paper placed therein between as the two plates come into engaging or almost engaging contact.

Thus, a fillister and a projecture are mutually jogged or offset and set on the relatively abutted surface of the two flat metal sheets according to the requirement for the patterns to be cut, and the contour lines of the fillister and projecture are provided through the manufacturing process with sharp trimming edges that can cut patterns.

The distances between the recesses and walls is generally between about 0.005 mm and 0.03 mm. The paper or other similarly cuttable material cut with such die patter cutter has a uniform, sharp edge with no significantly discernable roughness to produce a relatively clean cut edge.

In order to emboss the paper simultaneously while cutting, the plates include corresponding raised walls and wall-receiving recesses that are not provided with sharp edges. In addition, the raised walls and wall-receiving recesses are spaced a sufficient distance so as to prevent cutting of the material being embossed. By pressing the two plates together, the material being embossed is shaped by the contours formed by extruding with the projecture and fillister of the two metal plates. For the embossing features, the fillister is wider than the projecture with the distance between the two being at least as great as the thickness of a material being embossed (the specific distance depends on the thickness of the paper). As such, the pattern cut by the die cutter of the present invention may include both concave and convex features that have been embossed into the material during pressing.

In order to provide proper alignment of the two metal plates of the die cutter of the present invention, in one embodiment of the present invention, the two plates are adjoined along one side thereof with a hinge. Accordingly, one side of each of the two metal plates is provided with matching axel sleeves. An axel pin extends through the axel sleeves to allow the two plates to pivot relative to one another in a hinge-type manner. The axel pin is affixed to the axel sleeve(s) of one of the plates and rotatably coupled to the axel sleeve(s) of the other plate by a clearance fit. Thus, the ends of the said axel may be connected to the axle sleeves of one plate through interference fit with the center section of the axel pin connected to the axel sleeve of the other plate by transition fit or clearance fit, so that the two flat metal sheets will rotate relatively, and the axel pin will not slide out of the axle sleeve.

In yet another embodiment of the present invention, the fillisters and projectures of the two metal plates may be integrally formed with the metal plates by a casting process, acid etching process, machining process or any other process or method known in the art. Likewise, the fillisters and projectures may be processed separately and connected through adhesive attachment, chemical bonding, interference fit, welding or other methods known in the art.

If desired, the two metal plates having the fillister and projecture may be chrome plated after completion of their processing to improve the aesthetics of the surface finish, enhance the rigidity of the sharp cutting edge, prevent metal oxidation, and to extend the useful life of the product.

In another embodiment of the die cutter of the present invention, one of the two metal plates is provided with an aperture that is in the shape of the contour to be cut from a material placed between the two plates. The other metal plate has a projection formed thereon that has a contour to substantially match the contour of the aperture and so as to align with the aperture when cutting a material placed between the two plates. That is, the top edge of the projection is sharpened to engage with the sharpened edge of the aperture to provide a scissor-like cutting action when the projection is fitted into the aperture. As the material is cut between the projection and aperture, the material that is cut by the projection and aperture can drop or fall through the aperture.

The height of the projections and the depth of the corresponding receiving recesses are generally 0.3 mm to 1 mm. This is also the size of the radius of the external diameter of the axle sleeve. Typically, if the size is greater than 1 mm it is possible to damage the convex/concave shape of the paper that is formed by the embossing process. In order to match this size, the distance between the location of the projection or the recess that is nearest to the axel of the hinge, as previously discussed, should not be less than about 25 mm to ensure that the projection and recess properly engage. Because, in a hinging arrangement, the two plates rotate together, if the edge of the shape to be cut is too close to the hinge, the projection and recess for cutting will not properly engage due to the angle at which these two structures will engage. It is desirable to have the two plates engage in a relatively planar manner. Of course, the further from the axel of the hinge, the more planar the engagement between the two plates becomes to allow for proper engagement of the projection and recess. Thus, if the outer edge of the cutting projection is too close to the hinge, the cutting effect will not be as good nearer the hinge, producing a cutting effect near the hinge that is relatively poor with a cutting effect farthest from the hinge being comparatively better. In addition, the projection and recess near the hinge can be damaged.

In one embodiment of the die cutter of the present invention, an elastic pad is positioned between the two metal sheets. The elastic pad is connected to one metal sheet through an adhesive sticking, and generally located at the outside of the fillister and projection. The elastic pad provides a bias between the two sheets so as to open a gap between the two sheets after tabling and cutting to make it easier to open the two sheets to remove the cut pattern.

In order to produce a cut and embossed pattern in accordance with the principles of the present invention, the two plates are opened and a sheet of paper or other similar material is placed between the two plates such that the edges of the sheet of paper fully extend beyond the outer edge of the shape to be cut by the projection and fillister. The two plates are then closed around the sheet of paper and pressed together until the projection seats within the fillister and the sheet of paper is cut. The two plates are then opened and the sheet of paper removed. Because the paper has been cut, the outer contour of the cut portion of the paper will be identical to the design pattern provide by the two metal plates and will include embossed features that are pressed into the paper by the two metal plates.

Compared with existing technologies, the present invention has the following advantages and effect: (1) A hinge-type die cutter in accordance with the present invention can complete the operation of cutting patterns by itself, and no cutting pad is required. Thus, it is easy and convenient to use. (2) A hinge-type die cutter in accordance with the present invention can closed when it is not used to hide the sharp cutting edges therein. As such, an accidental cutting wound can be avoid. Thus, compared with existing technologies, the use of a hinge-type die cutter is safer and more reliable and may be fit for use by children. (3) Because a casting process can used to mass produce a hinge-type die cutter in accordance with the present invention, it is not necessary to manufacture a cutting blade separately and conduct tabling and assembly as is the case with some other die making technologies. Thus, production efficiency is greatly increased and its manufacturing cost is comparatively low for mass production. (4) The die cuts produced with a hinge-type die cutter in accordance with the present invention can have embossed details with significant three dimensional characteristics to produce vivid images having easily visible elevations similar to three-dimensional sculptures. Such embossing characteristics have a significantly better decorative effect than traditional flat die cuts and can represent a particular patter mold more directly and vividly. This is particularly helpful when being used by children as such features improve a child's cognition and identification. Thus, it increases the aesthetics of the image produced by adding a three-dimensional element to what is typically a flat, two-dimensional shape cut from a sheet of paper. (5) A hinge-type die cutter according to the present invention also has the advantage of being a compact structure, having a thin shape, small size, convenient packing, storage and moving and which has significant advantages over existing die cutters that are comparatively large (for their blades are relatively large and the blades are covered with a protective layer).

These and other advantages will become apparent from a reading of the following summary of the invention and description of the illustrated embodiments in accordance with the principles of the present invention.

### BRIEF DESCRIPTION OF THE DRAWINGS

The foregoing summary, as well as the following detailed description of the preferred embodiments is better understood when read in conjunction with the appended drawings. For the purpose of illustrating the invention, there is shown in the drawings embodiments that illustrate what is currently considered to be the best mode for carrying out the invention, it being understood, however, that the invention is not limited to the specific methods and instruments disclosed. In the drawings:

FIG. 1 is a perspective view of a first embodiment of a hinge-type pattern cutter in accordance with the principles of the present invention.

FIG. 2(A) is a perspective view of the hinge-type pattern cutter of FIG. 1 with a sheet of paper placed thereon for cutting and embossing.

FIG. 2(B) is a perspective view of the hinge-type pattern cutter of FIG. 2(A) in a folded configuration with the sheet of paper positioned therein.

FIG. 2(C) is a perspective view of the hinge-type pattern cutter of FIG. 2(B) in an open position after the paper has been cut and embossed with the hinge-type pattern cutter.

FIG. 2(D) is a perspective view of the paper shown in FIG. 2(C) with the pattern that has been cut therefrom in separated form.

FIG. 3 is a cross-sectional side view of a second embodiment of a die cutter in accordance with the principles of the present invention.

FIG. 4 is a cross-sectional side view of the die cutter of FIG. 3 with the two plates in engagement.

### DETAILED DESCRIPTION OF THE ILLUSTRATED EMBODIMENTS

Further detailed description is made for the present invention by combining the embodiment and attached figures, but the operation process of this invention is not limited to the following embodiment.

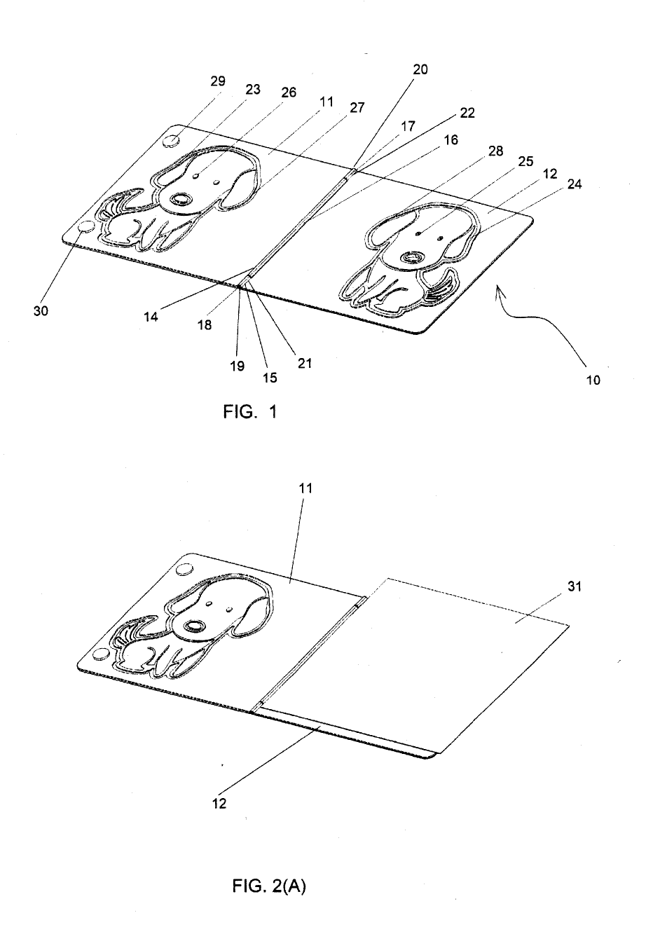

FIG. 1 shows one embodiment of a die cutter, generally indicated at 10 in accordance with the principles of the present invention. The die cutter 10 is in the form of a hinge-type die cutter and includes two flat metal plates or sheets 11 and 12. Two corresponding sides 14 and 15 of the two flat metal sheets 11 and 12 have matching axle sleeves 16 and 17. Axel pin 18 extends through the matching axle sleeves 16 and 17 to hinge the two flat metal sheets 11 and 12, forming the hinge-type structure 10, the two ends 19 and 20 of the axel pin 18 are connected to axle sleeves 21 and 22 through interference fit to prevent axel pin 18 from sliding out of axle sleeves 16 and 17. Simultaneously, axel pin 18 is coupled to axle sleeve 16 through clearance fit, so that the two flat metal sheets 11 and 12 can rotate freely relative to each other. The projection 23 and recess or fillister 24 are mutually offset so as to engage in a cutting manner. The projection 23 and recess 24 are formed on the facing surfaces of the metal plates 11 and 12, respectively. According to the dog patterns to be cut, and the contours of each of the projection 23 and recess 24 are processed with sharp trimming edges that can cut paper or other similar materials, such as card stock or other materials known in the art in sheet form. For example, the contour of the eyes and nose of the dog pattern are processed to through hole 25 on the plate 12 according to the requirements for the dog pattern and the eyes and nose of the dog pattern are processed to projection 26 on the plate 11. The fit of the projection 26 and through hole 25 enables them to extend through the hole to cut the flat material. The engagement of the recess 24, through hole 25 and projections 23 and 26 belong to an integral structure, which is formed through casting process at only one time.

The two plates 11 and 12 may be formed from metal and chrome-plated after completion of their processing to increase the surface finish and enhance the rigidity of the sharp cutting edge, so as to extend the useful life of the product. The height of projection 23 and the depth of recess or fillister 24 after processing is generally 0.3 mm to 1 mm. The distance between the outer contour edges 27 and 28 of the projection and recess nearest to the axel pin 18 is approximately 35 mm. As previously discussed herein, the size of the radius of the external diameter of the axle sleeve 16 is approximately the same size as the depth of the recess 24. Typically, if the size is greater than 1 mm when the two plates 11 and 12 are brought into engagement and the projections and recesses cut the paper, the convex/concave shape of the paper may become damaged resulting in a less than desirable end product that is formed by the embossing process. Also, the distance between the contour edges 27 and 28 of the projection and recess, respectively, nearest to the axel of the hinge should not be less than about 25 mm and is typically approximately 35 mm to ensure that the projection and recess properly engage. Because, in a hinging arrangement, the two plates 11 and 12 rotate into engagement, if the edge of the shape to be cut is too close to the hinge, the projection and recess for cutting will not properly engage due to the angle at which these two structures will engage. It is thus desirable to have the two plates 11 and 12 to engage in a relatively planar manner. Of course, the further from the axel of the hinge, the more planar the engagement between the two plates becomes to allow for proper engagement of the projection and recess. Thus, if the outer edges 27 and 28 are too close to the hinge, the cutting effect will not be as good nearer the hinge, producing a cutting effect near the hinge that is relatively poor with a cutting effect farthest from the hinge being comparatively better. In addition, the projection and recess near the hinge can be damaged by engagement between the projection and recess at an angle.

As further shown in FIG. 1, two elastic pads 29 and 30 are attached to the plate 11 as by an adhesive. When the two plates 11 and 12 are closed together the elastic pads 29 and 30 are “sandwiched” between the two plates 11 and 12. The elastic pads 29 and 30 may be formed from foam rubber or other elastomeric or resilient material so as to bias the two plates 11 and 12 away from each other when the two plates are engaged. The pads 29 and 30 are located proximate the outside of the pattern on plate 11. As such, after pressing the two plates together to cut a shape from a sheet of paper, the elastic pads 29 and 30 provide a slight opening between the two plates 11 and 12 equal to the thickness of the two elastic pads 29 and 30 to assist a user in opening the two plates in order to remove the pattern that has been cut with the two plates 11 and 12.

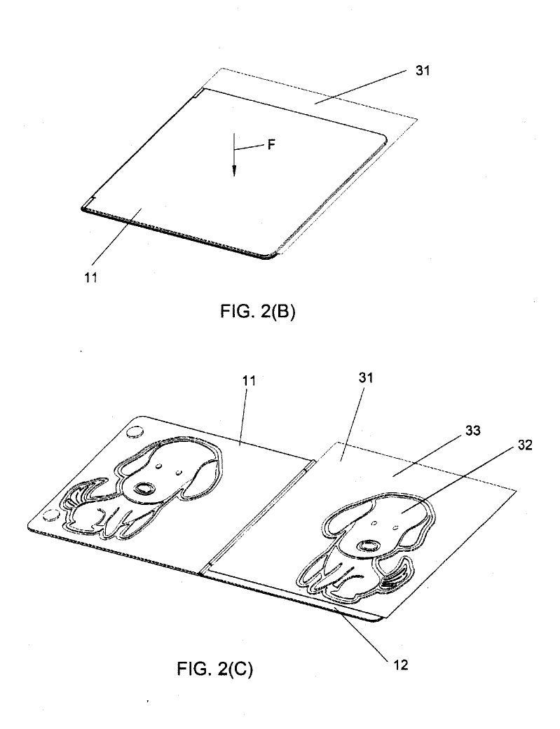

A method of forming a die cut pattern according to the principles of the present invention is illustrated in FIG. 2(A) through FIG. 2(D). As shown in FIG. 2A, the two metal plates 11 and 12 are opened. A sheet 31 of paper or other material in sheet form such as card stock or other materials known is placed n the art is placed over the cutting image of one of the two metal plates 11 or 12. In order to make sure that the entire design is cut into the sheet 31, the sheet 31 is placed over the entire image so that the outer contour of the image is behind the sheet 31. As shown in FIG. 2B, the two metal plates 11 and 12 are closed about the hinge so that the sheet 31 is positioned therein between. The two metal plates 11 and 12 are then pressed together with sufficient force F so as to cause the projections and recesses forming the image on the plates 11 and 12 to engage and cut the sheet 31. Such pressing may be accomplished by inserting the die cutter 10 into a die press machine of which there are many such die press machines known in the art. Once the sheet 31 has been cut, as shown in FIG. 2C, the two plates 11 and 12 are opened about the hinge to reveal the sheet 31 in cut form comprising at least two parts, the dog pattern 32 and an unpressed part 33. Finally, as shown in FIG. 2D, the two parts 32 and 33 are removed from the two plates 11 and 12 to reveal the dog pattern die cut 32 whose contour and shape are identical with the dog pattern in the two metal plates. In addition, the pattern die cut 32 is embossed to accentuate various features 34, 35, and 36, for example, of the pattern.

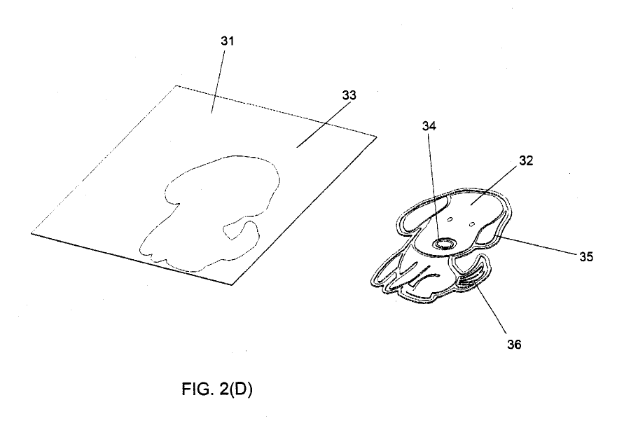

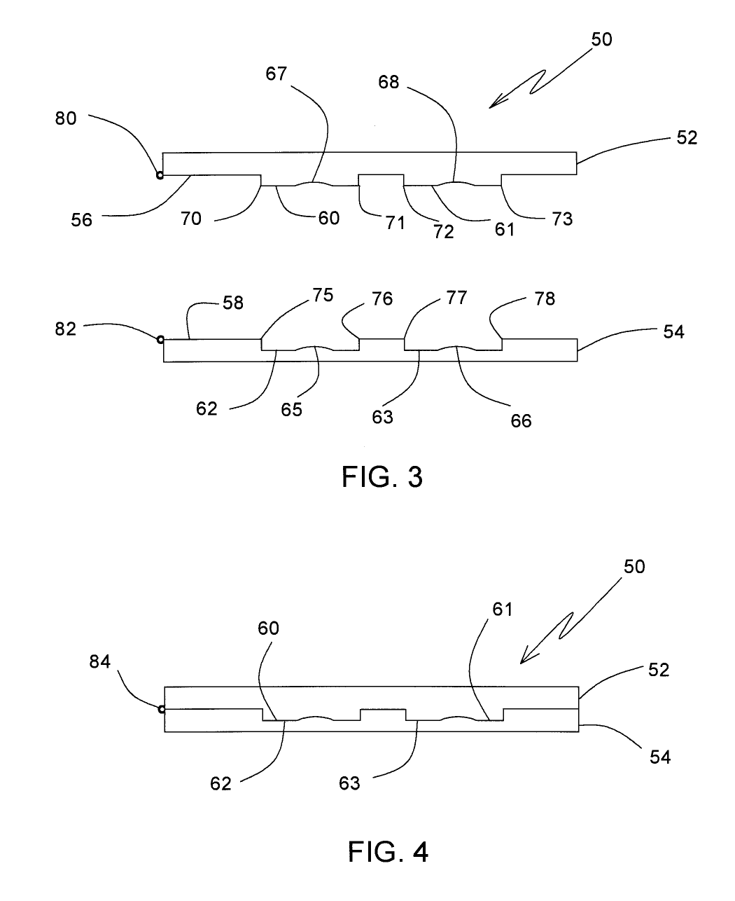

As shown in FIG. 3, a die cutter, generally indicated at 50, is formed from two plates 52 and 54. Each plate 52 and 54 has a mating surface 56 and 58, respectively, for mating with the other plate. Each mating surface 56 and 58 defines projections and/or recesses that define a particular image that is to be cut and embossed therefrom. For example, the projections 60 and 61 mate with recesses 62 and 83 of plate 53 for cutting. In addition, projections 65 and 66 mate with recesses 67 and 68 of plate 52 for embossing. The cutting projections 60 and 62 are provided with sharpened edges 70-73 that engage in a scissor-like manner with sharpened edges 75-78 of recesses 62 and 63. This engagement is shown in FIG. 4. in which the two plates 52 and 54 are sandwiched together. The projections 65 and 66 and recesses 67 and 68 do not provide edges that would cut material interposed between the two plates 52 and 54. While shown as being completely engaged over the entire surfaces 56 and 58, there is actually a small gap between the two plates 52 and 54 to accommodate the thickness of a sheet of paper or other similar material to bet cut and embossed. The hinge sleeves 80 and 82 are held relative to one another with the hinge pin 84 shown in FIG. 4.

The embodiment of a hinge-type die cutter of the present invention is provided by way of example and not limitation. The operation process of this invention is not limited to above-mentioned embodiment, any change, decoration or substitute without deviating from the concept and technology of this invention is equivalent replacement, and included the protection range of this invention. Thus, While the methods and apparatus of the present invention have been described with reference to certain preferred embodiments to illustrate what is believed to be the best mode of the invention, it is contemplated that upon review of the present invention, those of skill in the art will appreciate that various modifications and combinations may be made to the present embodiments without departing from the spirit and scope of the invention as recited in the claims. The claims provided herein are intended to cover such modifications and combinations and all equivalents thereof. Reference herein to specific details of the illustrated embodiments is by way of example and not by way of limitation.

What is claimed is:

1. A die cutter, comprising:
a first metal plate having at least one raised projection formed thereon having a first sharpened top edge;
a second metal plate having at least one recess formed therein and defining a second sharpened top edge.
a hinge structure hinging said first and second metal plates such that when said first and second metal plates come together, said first sharpened top edge is positioned to be proximate said second sharpened top edge so as to cut a sheet of material placed therein between.

2. The die cutter of claim 1, wherein said at least one raised projection is integrally formed with said first metal plate and said at least one recess is integrally formed with said second metal plate.

3. The die cutter of claim 2, wherein said first and second metal plates are formed from cast metal.

4. The die cutter of claim 1, wherein said at least one projection is attached to said first metal plate by at least one of an adhesive, a weld, a chemical bond or an interference fit.

5. The die cutter of claim 1 wherein said first and second metal plates are chrome-plated.

6. The die cuter of claim 1 wherein at least one of said first and second metal plates is defines an aperture with the other of the first and second metal plates having a projection for engaging said aperture.

7. The die cutter of claim 1 wherein said projection has a height of between approximately 3 mm and 1 mm.

8. The die cutter of claim 7, wherein said recess has a depth approximately equal to said height of said projection.

9. The die cutter of claim 1, wherein a distance between an edge of said projection or recess nearest said hinge structure is not less than approximately 25 mm.

10. The die cutter of claim 1, wherein said hinge structure is comprised of at least one hinge sleeve coupled to each of said first and second metal plates and a hinge pin positioned within said hinge sleeves.

11. The die cutter of claim 10, wherein the ends of said hinge pin are connected to said at least one axel sleeve one of said first and second metal plates and connect to said at least one axel sleeve of the other of said first and second metal plates by a clearance fit to allow said hinge pin to rotate therein.

12. The die cutter of claim 1, further including at least one elastic pad is attached to one of said first and second metal plate for biasing said first and second metal plates away form one another when in a closed position.

13. The die cutter of claim 12, wherein said at least one elastic pad is located at an outside of projection and recess of the first and second metal plates.
